(19) United States
(12) Patent Application Publication
(10) Pub. No.: US 2020/0001576 A1
(43) Pub. Date: Jan. 2, 2020

(54) ASYMMETRIC GLASS LAMINATES

(71) Applicant: CORNING INCORPORATED, Corning, NY (US)

(72) Inventors: Thomas Michael Cleary, Elmira, NY (US); Andrew Peter Kittleson, Honeoye Falls, NY (US); Yousef Kayed Qaroush, Painted Post, NY (US); Thomas M. Tremper, Painted Post, NY (US); Bo Yang, Dublin, CA (US)

(21) Appl. No.: 16/456,291

(22) Filed: Jun. 28, 2019

Related U.S. Application Data
(60) Provisional application No. 62/776,015, filed on Dec. 6, 2018.
(60) Provisional application No. 62/732,760, filed on Sep. 18, 2018.
(60) Provisional application No. 62/691,279, filed on Jun. 28, 2018.

(51) Int. Cl. B32B 17/10; B60J 1/00

(52) U.S. Cl. CPC B32B 17/10036; B32B 2331/04; B60J 1/001; B32B 17/10788; B32B 17/1077; B32B 2605/08; B32B 2605/10; B32B 2605/18; B32B 2605/006; B32B 2607/00; B32B 2327/06; B32B 2329/06; B32B 2250/03; B32B 2375/00; B32B 2307/54; B32B 17/10137

(57) ABSTRACT

Principles and embodiments of the present disclosure relate to unique asymmetric laminates and methods that produce the laminates where the laminate includes an first glass substrate having a first thickness (tₒ), an second glass substrate having a second thickness (tᵢ), an interlayer disposed between the second glass substrate and the first glass substrate, wherein the first thickness and the second thickness has a combined third thickness (tₜ), and wherein tₒ/tₜ or tᵢ/tₜ is in a range from about 0.7 to about 0.99.

### CROSS-REFERENCE TO RELATED APPLICATIONS

This application claims the benefit of priority under 35 U.S.C. § 119 of U.S. Provisional Application Ser. No. 62/691,279 filed on Jun. 28, 2018 and U.S. Provisional Application Ser. No. 62/732,760 filed on Sep. 18, 2018 and U.S. Provisional Application Ser. No. 62/776,015 filed on Dec. 6, 2018, the content of which are relied upon and incorporated herein by reference in their entirety.

This disclosure relates to laminates comprising a relatively thick glass substrate and a relatively thin glass substrate, and more particularly to laminates having specific thickness ratios that provide reduced stress on a surface after impact with a projectile.

### BACKGROUND

Laminates can be used as windows and glazing in architectural and transportation applications (e.g., vehicles including automobiles and trucks, rolling stock, locomotive and airplanes). Laminates can also be used as panels in balustrades and stairs, and as decorative panels or covering for walls, columns, elevator cabs, kitchen appliances and other applications. The laminates may be transparent, semi-transparent, translucent or opaque and may comprise part of a window, panel, wall, enclosure, sign or other structure. Common types of such laminates may also be tinted or colored or include a component that is tinted or colored.

In certain applications, laminates having high mechanical strength, resistance to damage from impinging objects may be useful to provide a barrier while reducing the potential of at least one substrate forming the laminate fracturing due to surface cracks. In embodiments in which one glass substrate has a different thickness from the other thickness, one surface of the thinner glass substrate may experience significantly greater stress than the thicker substrate, which can degrade overall laminate mechanical strength and/or resistance to damage from impinging objects. Accordingly, there is a need for laminates having asymmetry in the thickness of each glass substrate that also maintain mechanical strength and/or resistance to damage from impinging objects.

### SUMMARY

A first aspect of this disclosure pertains to a laminate comprising a first glass substrate comprising a first thickness (tₒ); a second glass substrate a second thickness (tᵢ) that differs from to; and an interlayer disposed between and adhered to the first glass substrate and the second glass substrate, wherein the first thickness and the second thickness has a combined third thickness (tₜ), and wherein tₒ/tₜ or tᵢ/tₜ is in a range from about 0.7 to about 0.99. When the first outer surface is impacted at normal incidence with a 1 gram ball bearing traveling at a speed of 45 mph, the fourth inner surface experiences a flexural stress (σᵣᵣ) of no more than σᵣᵣ=10.344tₜ²−109.33tₜ+347.75 as measured by strain gauge for tₜ in a range of from 2 mm to 7 mm.

In one or more embodiments, the second glass substrate comprises a soda-lime silicate glass composition, an aluminosilicate glass composition, or an alkali aluminosilicate glass composition. In one or more embodiments, the second glass substrate may include a strengthened glass substrate. For example, in one or more embodiments, the second glass substrate comprises a surface compressive stress (CS) in a range from about 50 MPa to 300 MPa. In one or more embodiments, the second glass substrate comprises a depth of compression (DOC) in a range from about 30 μm to about 90 μm.

In one or more embodiments, the second glass substrate may be unstrengthened. In some embodiments, the second glass substrate comprises an annealed glass substrate.

In one or more embodiments, the interlayer is a polymer selected from the group consisting of polyvinyl butyral, ethylenevinylacetate, polyvinyl chloride, ionomers, and thermoplastic polyurethane. The interlayer may have a thickness of about 2 mm or greater. In some embodiments, the interlayer has a modulus of elasticity of about 200 MPa or less.

The laminate may be an automotive glazing or an architectural panel. In one or more embodiments, the first glass substrate may form the exterior facing substrate of the automotive glazing or architectural panel, and the second glass substrate may form the interior facing substrate of the automotive glazing or architectural panel.

In another aspect, embodiments of the disclosure relate to a laminate. The laminate includes a first glass substrate having a first thickness (tₒ) between a first outer surface and a second inner surface and a second glass substrate having a second thickness (tᵢ) that is less than to between a third outer surface and a fourth inner surface. The laminate also includes an interlayer disposed between and adhered to second inner surface and the third outer surface. A third thickness (tt) is the sum of to and ti. When the first outer surface is impacted at normal incidence with a 1 gram ball bearing traveling at a speed of 45 mile per hour, the fourth inner surface exhibits a flexural stress of less than about 150 MPa, as measured by a strain gage, for tt of 2.4 mm or greater.

A third aspect of this disclosure pertains to a vehicle comprising: a body defining an interior; an opening in the body in communication with the interior; and a laminate as described herein disposed in the opening. In one or more embodiments, the body comprises an automobile body, a railcar body, or an airplane body. In some instances, the second glass substrate faces the interior.

A fourth aspect of this disclosure pertains to an architectural panel comprising the laminate as described herein, wherein the panel comprises a window, an interior wall panel, a modular furniture panel, a backsplash, a cabinet panel, or an appliance panel.

In still another aspect, embodiments of the disclosure relate to an automotive glazing. The automotive glazing includes a first glass substrate having a first thickness (to) and a first outer surface and a second inner surface and a second glass substrate having a second thickness (ti) that is less than to, a third outer surface, and a fourth inner surface. An interlayer is disposed between the second inner surface and the third outer surface. A third thickness (tt) is equal to the sum of to and ti. A ratio to/tt is in a range of from 0.95 to 0.999, and ti is less than 0.1 mm and tt is in a range of from 2 mm to 5 mm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

Further features of embodiment of the present disclosure, their nature and various advantages will become more apparent upon consideration of the following detailed description, taken in conjunction with the accompanying drawings, which are also illustrative of the best mode contemplated by the applicants, and in which like reference characters refer to like parts throughout, where:

FIG. 1A illustrates an embodiment of a laminate.

FIG. 1B illustrates an alternative embodiment of a first glass laminate,

FIG. 2 illustrates another exemplary embodiment of a laminate comprising a second glass substrate and a first glass substrate.

FIG. 3 is a perspective view of a vehicle according to one or more embodiments.

FIGS. 4A-4C are graphs showing predicted stress on various surfaces of various laminates, as a function of tₒ/tₜ ratio for several total glass thickness values for laminates upon impact with a 1 g ball bearing at 45 MPH and at normal incidence.

FIGS. 5A-5B depict the experimental setup for the ball bearing impact test.

FIG. 6 depicts data gathered from the ball bearing impact test shown in FIGS. 5A-5B.

FIG. 7 provides the experimental data of FIG. 6 overlaid the predicted data of FIG. 4A.

FIG. 8 is a graph of the velocity required to induce breakage in a 45° ball bearing impact test.

FIGS. 9-12 are graphs showing the percentage of certain failure modes as a function of tₒ/tₜ ratios.

FIGS. 13 and 14 depict a dart used in various dart impact tests.

FIGS. 15-17 depict data gathered from the various dart impact tests.

### DETAILED DESCRIPTION

Before describing several exemplary embodiments, it is to be understood that the disclosure is not limited to the details of construction or process steps set forth in the following disclosure. The disclosure provided herein is capable of other embodiments and of being practiced or being carried out in various ways.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

As used herein, the phrase “laminates,” which may also be referred to as “laminate structures,” laminate glass structures, or “glazings,” relates to a transparent, semitransparent, translucent or opaque glass-based material. Aspects of this invention pertain to laminates and vehicles and architectural panels that incorporate such structures. Laminates according to one or more embodiments comprise at least two glass substrates (i.e., a first glass substrate and a second glass substrate) that have differing thicknesses. In one or more embodiments, the first glass substrate is thicker than the second glass substrate. In one or mero embodiments, the first glass substrate is thinner than the second glass substrate. In one or more embodiments, the laminate may be an automotive glazing in which the second glass substrate is exposed to a vehicle or automobile interior and the first glass substrate faces an outside environment of the automobile. In one or more embodiments of such automotive glazings, the first glass substrate is exposed to a vehicle or automobile interior and the second glass substrate faces an outside environment of the automobile. In architectural applications, the second glass substrate is exposed to a building, room, or furniture interior and the first glass substrate faces an outside environment of the building, room or furniture. In one or more embodiments, architectural applications, the first glass substrate is exposed to a building, room, or furniture interior and the second glass substrate faces an outside environment of the building, room or furniture. In one or more embodiments, the first glass substrate and second glass substrate are bonded together by an interlayer. In the laminate, the surface of the glass substrate that forms the exterior facing surface of the laminate is a first outer surface (sometimes referred to as surface one), the surface of the glass substrate that opposes the first outer surface is a second inner surface (sometimes referred to as surface two), the surface of the other glass substrate that is adjacent to the second inner surface is a third outer surface (sometimes referred to as surface three), and the surface of the other glass substrate that opposes the third outer surface is the fourth inner surface (sometimes referred to as surface four).

During use, it is desirable that the glass laminate resist fracture in response to external impact events. The various embodiments of the laminate exhibits reduced stress on the fourth inner surface when the first outer surface is impacted by a projectile (such as a stone or other projectile).

In automotive glazings, a main cause of windshield replacements in the field is due to stone impact. Stone impact can cause fracture of the windshield by several mechanisms including blunt (Hertzian) contact, sharp contact and flexure. Blunt (Hertzian) contact creates a ring/cone crack which initiates from an existing flaw on the first outer surface that faces the exterior of the automobile. The flaw propagates through the thickness of the glass substrate and then creates radial/median cracks. Flexure of the laminate activates flaws on the fourth inner surface that faces the interior of the vehicle). To optimize impact resistance, it would be desirable to address one or more of these mechanisms. As laminates are made thinner, flexure becomes more critical as the greater deflection during impact will result in higher and larger stress fields on the second and fourth inner surfaces.

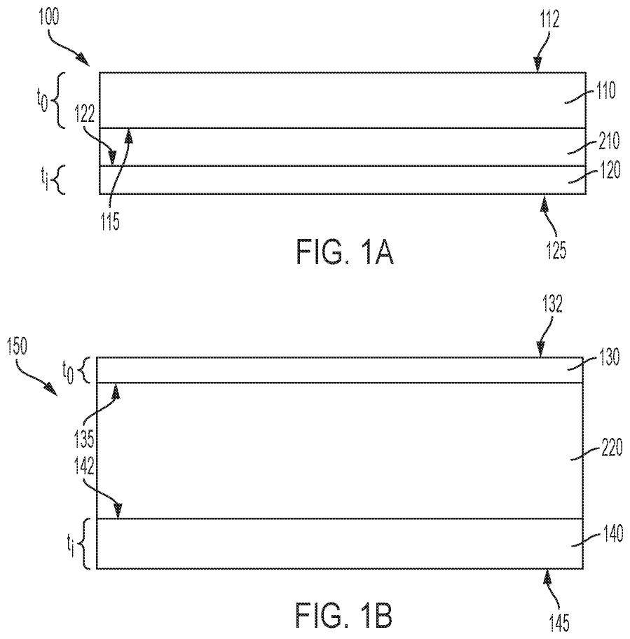

FIG. 1A illustrates an embodiment of a laminate 100. The laminate includes a first glass substrate 110, a second glass substrate 120, and an interlayer 210 disposed between and adhered to the first glass substrate and the second glass substrate. The first glass substrate 110 has a first outer surface 112 and a second inner surface 115 opposite the first outer surface. The second glass substrate 120 has a third outer surface 122 and a fourth inner surface 125 opposite the third outer surface. The interlayer 210 is adhered to the second inner surface 115 and the third outer surface 122. The first glass substrate 110 has a first thickness (tₒ), the second glass substrate 120 has a second thickness (tᵢ) that differs from the first glass substrate. In the embodiment shown, the first glass substrate 110 is thicker than the second glass substrate.

FIG. 1B illustrates an embodiment of a laminate 150 that includes a thinner first glass substrate 130 than the second glass substrate 140. The laminate 150 includes an optionally thicker interlayer 220 disposed between and adhered to the first and second glass substrate. In FIG. 1B, the first glass substrate 130 has a first outer surface 132 and a second inner surface 135 opposite the first outer surface. The second glass substrate 140 has a third outer surface 142 and a fourth inner surface 145 opposite the third outer surface. The interlayer 220 is adhered to the second inner surface 135 and the third outer surface 142. The first glass substrate 130 has a first thickness (tₒ), the second glass substrate 140 has a second thickness (tᵢ) that differs from the first glass substrate. In the embodiment shown, the first thickness is less than the second thickness.

As mentioned herein, either one or both the first glass substrate and the second glass substrate are unstrengthened. As mentioned herein, either one or both the first glass substrate and the second glass substrate are annealed. As mentioned herein, either one or both the first glass substrate and the second glass substrate is strengthened.

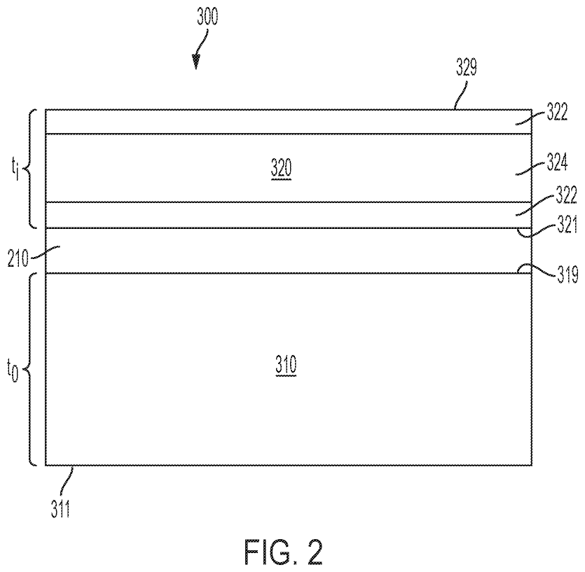

FIG. 2 illustrates an embodiment of a laminate 300 having an first glass substrate 310 and a second glass substrate 320 that is strengthened. The first glass substrate 310 has a first thickness (tₒ), the second glass substrate 320 has a second thickness (tᵢ) that differs from the first glass substrate. In the embodiment shown, the second glass substrate is thinner than the first glass substrate, however the second glass substrate may be thicker than the first glass substrate. The second glass substrate 320 is shown as a strengthened substrate, and it will be understood that in one or more embodiments, the first glass substrate 310 can be unstrengthened, for example, an annealed glass substrate such as a soda lime glass substrate. The first glass substrate includes a first outer surface 311, and a second inner surface 319. The second glass substrate includes a third outer surface 321 and a fourth inner surface 329. The laminate 300 can be arranged used as an automotive or architectural glazing such that the first outer surface 311 faces an external environment (e.g., the exterior of the automobile or building), and the fourth inner surface 329 faces the internal environment (e.g., the inside of an automobile or a building).

In the various embodiments, the first glass substrate has a first thickness (tₒ) defined as the distance between the first outer surface and the second inner surface. In the various embodiments, the second glass substrate has a second thickness (tᵢ) defined as the distance between the third outer surface and the fourth inner surface. As described herein, to and tᵢ differ. Further, the first and second glass substrates have a combined thickness (tₜ) that is equal to the sum of the first thickness (tₒ) and the second thickness (tᵢ). That is, tₜ is equal to tₒ+tᵢ.

In one or more embodiments, the first thickness (tₒ) and/or the second thickness (tᵢ) is in the range from about 0.01 mm to about 6 mm, from about 0.05 mm to about 6 mm, from about 0.1 mm to about 6 mm, from about 0.25 mm to about 6 mm, from about 0.5 mm to about 6 mm, from about 0.55 mm to about 6 mm, from about 0.6 mm to about 6 mm, from about 0.7 mm to about 6 mm, from about 0.8 mm to about 6 mm, from about 0.9 mm to about 6 mm, from about 1 mm to about 6 mm, from about 1.2 mm to about 6 mm, from about 1.4 mm to about 6 mm, from about 1.5 mm to about 6 mm, from about 1.6 mm to about 6 mm, from about 1.8 mm to about 6 mm, from about 2 mm to about 6 mm, from about 2.1 mm to about 6 mm, from about 2.2 mm to about 6 mm, from about 2.3 mm to about 6 mm, from about 2.4 mm to about 6 mm, from about 2.5 mm to about 6 mm, from about 3 mm to about 6 mm, from about 3.5 mm to about 6 mm, from about 4 mm to about 6 mm, from about 5 mm to about 6 mm, from about 0.1 mm to about 5.5 mm, from about 0.1 mm to about 5 mm, from about 0.1 mm to about 4.5 mm, from about 0.1 mm to about 4 mm, from about 0.1 mm to about 3.8 mm, from about 0.1 mm to about 3.6 mm, from about 0.1 mm to about 3.5 mm, from about 0.1 mm to about 3.4 mm, from about 0.1 mm to about 3.2 mm, from about 0.1 mm to about 3 mm, from about 0.1 mm to about 2.8 mm, from about 0.1 mm to about 2.6 mm, from about 0.1 mm to about 2.5 mm, from about 0.1 mm to about 2.4 mm, from about 0.1 mm to about 2.3 mm, from about 0.1 mm to about 2.1 mm, from about 0.1 mm to about 2 mm, from about 0.1 mm to about 1.8 mm, from about 0.1 mm to about 1.7 mm, from about 0.1 mm to about 1.6 mm, from about 0.1 mm to about 1.5 mm, from about 0.1 mm to about 1.4 mm, from about 0.1 mm to about 1.2 mm, from about 0.1 mm to about 1 mm, from about 0.1 mm to about 0.7 mm. The thickness values described herein are maximum thicknesses.

In one or more embodiments, the first thickness (tₒ) may be in a range from about 1.5 mm to about 6 mm, about 1.5 mm to about 5.5 mm, 1.5 mm to about 5 mm, about 1.5 mm to about 4.5 mm, about 1.5 mm to about 4 mm, about 1.5 to about 3.9 mm about 1.5 to about 3.8 mm, about 1.5 to about 3.7 mm, about 1.5 to about 3.6 mm about 1.5 to about 3.5 mm, about 1.5 to about 3.4 mm, about 1.5 to about 3.3 mm about 1.5 to about 3.2 mm about 1.5 to about 3.1 mm, about 1.5 to about 3 mm, about 1.5 to about 2.9 mm, about 1.5 to about 2.8 mm about 1.5 to about 2.7 mm, about 1.5 to about 2.6 mm, about 1.5 to about 2.5 mm about 1.5 to about 2.4 mm about 1.5 to about 2.3 mm, about 1.5 to about 2.2 mm, about 1.5 to about 2.1 mm, about 1.5 to about 2 mm, about 1.5 to about 1.9 mm, about 1.5 to about 1.8 mm, about 1.5 to about 1.7 mm, or about 1.5 to about 1.6 mm.

In one or more embodiments, the second thickness (tᵢ) may be in the range from about 0.01 mm up to about 1.5 mm, from about 0.01 mm to about 1.4 mm, from about 0.01 mm to about 1.3 mm, from about 0.01 mm to about 1.2 mm, from about 0.01 mm to about 1.1 mm, from about 0.01 mm to about 1 mm, from about 0.01 to about 0.9 mm, from about 0.01 to about 0.8 mm, from about 0.01 to about 0.7 mm, from about 0.01 to about 0.6 mm, from about 0.01 to about 0.5 mm, from about 0.01 to about 0.4 mm, from about 0.01 to about 0.3 mm, from about 0.01 to about 0.2 mm, from about 0.01 to about 0.15 mm, from about 0.01 to about 0.05 mm, from about 0.01 mm up to about 1.5 mm, from about 0.05 to about 1.5 mm, from about 0.1 to about 1.5 mm, from about 0.2 mm up to about 1.5 mm, from about 0.3 mm up to about 1.5 mm, from about 0.4 mm up to about 1.5 mm, from about 0.5 mm up to about 1.5 mm, from about 0.55 mm up to about 1.5 mm, from about 0.6 mm up to about 1.5 mm, from about 0.7 mm up to about 1.5 mm, from about 0.8 mm up to about 1.5 mm, from about 0.9 mm up to about 1.5 mm, or from about 1 mm up to about 1.5 mm.

In one or more embodiments, the laminate exhibits the ratio of thicknesses (tₒ/tₜ), a ratio of thickness (tᵢ/tₜ), or both the ratios of (tₒ/tₜ) and (tᵢ/tₜ) in a range from 0.7 to about 0.99 (e.g., from about 0.75 to about 0.99, from about 0.8 to about 0.99, from about 0.85 to about 0.99, from about 0.9 to about 0.99, from about 0.95 to about 0.99, from about 0.7 to about 0.95, from about 0.7 to about 0.9, from about 0.7 to about 0.85, from about 0.7 to about 0.8, from about 0.7 to about 0.75, or from about 0.85 to about 0.95.

In one or more embodiments, the laminate has a tₜ of 4.2 mm, and a ratio (tₒ/tₜ) of 0.71 (e.g., to may be 3.0 mm and tᵢ may be 1.2 mm). In one or more embodiments, the laminate has a tₜ of 4.2 mm, and a ratio (tₒ/tₜ) of 0.8 (e.g., to may be 3.4 mm and tᵢ may be 0.8 mm). In one or more embodiments, the laminate has a tₜ of 4.2 mm, and a ratio (tₒ/tₜ) of 0.9 (e.g., to may be 3.8 mm and tᵢ may be 0.4 mm).

In one or more embodiments, the laminate has a tₜ of 3.3 mm, and a ratio (tₒ/tₜ) of 0.7 (e.g., to may be 2.3 mm and tᵢ may be 1.0 mm). In one or more embodiments, the laminate has a tₜ of 3.3 mm, and a ratio (tₒ/tₜ) of 0.8 (e.g., to may be 2.6 mm and tᵢ may be 0.7 mm). In one or more embodiments, the laminate has a tₜ of 3.3 mm, and a ratio (tₒ/tₜ) of 0.9 (e.g., to may be 3.0 mm and tᵢ may be 0.3 mm).

In one or more embodiments, the laminate has a tₜ of 2.4 mm, and a ratio (tₒ/tₜ) of 0.7 (e.g., to may be 1.7 mm and tᵢ may be 0.7 mm). In one or more embodiments, the laminate has a tₜ of 2.4 mm, and a ratio (tₒ/tₜ) of 0.8 (e.g., to may be 1.9 mm and tᵢ may be 0.5 mm). In one or more embodiments, the laminate has a tₜ of 2.4 mm, and a ratio (tₒ/tₜ) of 0.9 (e.g., to may be 2.2 mm and tᵢ may be 0.2 mm).

In one or more embodiments, the first and second glass substrates have a substantially uniform thickness. In one or more embodiments, one of or both of the first and second glass substrates may have a wedge shape. In such embodiments, the thickness of the glass substrate at one edge may be greater than the thickness of the opposite edge. In one or more embodiments, the longest edges of the external strengthened glass substrate have thicknesses that differ from one another, while the thicknesses of the other edges (shorter edges) are the same with respect to one another but vary along the length thereof to form the wedge shape.

In one or more embodiments, the first or second glass substrate may be strengthened. In one or more embodiments, the strengthened glass substrate may be strengthened to include compressive stress that extends from a surface to a depth of compression (DOC) (provided as micrometers or a fraction of tₜ. The compressive stress regions having a surface compressive stress (CS) value are balanced by a central portion exhibiting a tensile stress. At the DOC, the stress changes from a compressive stress to a tensile stress. The compressive stress and the tensile stress (CT) values are provided herein as absolute values. The CT values provided herein are a maximum value.

The CT and CS values are provided herein in units of megaPascals (MPa) and as absolute values, though the CS is typically a negative stress and the CT is a positive stress.

CS and DOC are measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method.

In one or more embodiments, CS is related to the CT by the following approximate relationship (Equation 1): CT≈(CS×DOC)/(thickness-2×DOC), where thickness is the thickness of the strengthened glass substrate in micrometers.

In one or more embodiments, the glass substrate may be strengthened mechanically by utilizing a mismatch of the coefficient of thermal expansion between portions of the article to create a compressive stress region and a central region exhibiting a tensile stress. In some embodiments, the glass substrate may be strengthened thermally by heating the glass to a temperature above the glass transition point and then rapidly quenching.

In one or more embodiments, the glass substrate may be chemically strengthening by ion exchange. In the ion exchange process, ions at or near the surface of the glass substrate are replaced by—or exchanged with—larger ions having the same valence or oxidation state. In those embodiments in which the glass substrate comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass substrate generate a stress.

Ion exchange processes are typically carried out by immersing a glass substrate in a molten salt bath (or two or more molten salt baths) containing the larger ions to be exchanged with the smaller ions in the glass substrate. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the glass substrate in a salt bath (or baths), use of multiple salt baths, additional steps such as annealing, washing, and the like, are generally determined by the composition of the glass substrate (including the structure of the article and any crystalline phases present) and the desired DOC and CS of the glass substrate that results from strengthening. Exemplary molten bath composition may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass substrate thickness, bath temperature and glass (or monovalent ion) diffusivity. However, temperatures and immersion times different from those described above may also be used.

In one or more embodiments, the glass substrates may be immersed in a molten salt bath of 100% NaNO₃, 100% KNO₃, or a combination of NaNO₃ and KNO₃ having a temperature from about 370° C. to about 480° C. In some embodiments, the glass substrate may be immersed in a molten mixed salt bath including from about 1% to about 99% KNO₃ and from about 1% to about 99% NaNO₃. In one or more embodiments, the glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

In one or more embodiments, the first and/or second glass substrate may be strengthened to exhibit a DOC that is described a fraction of the thickness t of the glass substrate (as described herein). For example, in one or more embodiments, the DOC may be equal to or greater than about 0.05t, equal to or greater than about 0.1t, equal to or greater than about 0.11t, equal to or greater than about 0.12t, equal to or greater than about 0.13t, equal to or greater than about 0.14t, equal to or greater than about 0.15t, equal to or greater than about 0.16t, equal to or greater than about 0.17t, equal to or greater than about 0.18t, equal to or greater than about 0.19t, equal to or greater than about 0.2t, equal to or greater than about 0.21t. In some embodiments, The DOC may be in a range from about 0.08t to about 0.25t, from about 0.09t to about 0.25t, from about 0.18t to about 0.25t, from about 0.11t to about 0.25t, from about 0.12t to about 0.25t, from about 0.13t to about 0.25t, from about 0.14t to about 0.25t, from about 0.15t to about 0.25t, from about 0.08t to about 0.24t, from about 0.08t to about 0.23t, from about 0.08t to about 0.22t, from about 0.08t to about 0.21t, from about 0.08t to about 0.2t, from about 0.08t to about 0.19t, from about 0.08t to about 0.18t, from about 0.08t to about 0.17t, from about 0.08t to about 0.16t, or from about 0.08t to about 0.15t. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm.

In one or more embodiments, the strengthened glass substrate may have a CS (which may be found at the surface or a depth within the glass substrate) of less than about 300 MPa. For example, the CS may be in a range from about 10 MPa to about less than about 300 MPa, from about 20 MPa to about less than about 300 MPa, from about 25 MPa to about less than about 300 MPa, from about 30 MPa to about less than about 300 MPa, from about 40 MPa to about less than about 300 MPa, from about 50 MPa to about less than about 300 MPa, from about 60 MPa to about less than about 300 MPa, from about 70 MPa to about less than about 300 MPa, from about 80 MPa to about less than about 300 MPa, from about 90 MPa to about less than about 300 MPa, from about 100 MPa to about less than about 300 MPa, from about 120 MPa to about less than about 300 MPa, from about 130 MPa to about less than about 300 MPa, from about 140 MPa to about less than about 300 MPa, from about 160 MPa to about less than about 300 MPa, from about 170 MPa to about less than about 300 MPa, from about 180 MPa to about less than about 300 MPa, from about 190 MPa to about less than about 300 MPa, from about 200 MPa to about less than about 300 MPa, from about 10 MPa to about 290 MPa, from about 10 MPa to about 280 MPa, from about 10 MPa to about 270 MPa, from about 10 MPa to about 260 MPa, from about 10 MPa to about 250 MPa, from about 10 MPa to about 240 MPa, from about 10 MPa to about 230 MPa, from about 10 MPa to about 220 MPa, from about 10 MPa to about 210 MPa, from about 10 MPa to about 200 MPa, from about 10 MPa to about 190 MPa, from about 10 MPa to about 180 MPa, from about 10 MPa to about 170 MPa, from about 10 MPa to about 160 MPa, from about 10 MPa to about 150 MPa.

In one or more embodiments, the strengthened glass substrate may have a maximum tensile stress or central tension (CT) of about 50 MPa or less.

In one or more embodiments, the first glass substrate is laminated to the second strengthened glass substrate by an interlayer. In various embodiments, the interlayer is a polymer interlayer selected from the group consisting of polyvinyl butyral (PVB), ethylenevinylacetate (EVA), polyvinyl chloride (PVC), ionomers, and thermoplastic polyurethane (TPU). The interlayer may be applied as a preformed polymer interlayer. In some instances, the polymer interlayer can be, for example, a plasticized polyvinyl butyral (PVB) sheet. In various embodiments, the polymer interlayer can comprise a monolithic polymer sheet, a multilayer polymer sheet, or a composite polymer sheet.

The interlayer may have a thickness of at least 0.125 mm, or at least 0.25 mm, or at least 0.38 mm, or at least 0.5 mm, or at least 0.7 mm, or at least 0.76 mm, or at least 0.81 mm, or at least 1.0 mm, or at least 1.14 mm, or at least 1.19 mm, at least 1.2 mm, at least 1.4 mm, at least 1.5 mm, at least 1.6 mm, at least 1.8 mm, at least 2 mm, at least 2.1 mm, at least 2.2 mm, at least 2.3 mm, or at least 2.4 mm. The interlayer may have a thickness of from 0.76 mm to 2.5 mm. In various embodiments, the interlayer can cover most or, preferably, substantially all of the two opposed major faces of the strengthened glass substrates. The interlayer may also cover the edge faces of the strengthened glass substrates. In one or more embodiments, the interlayer may have a wedge shape or may have a substantially uniform thickness. In one or more embodiments, the thickness of the interlayer along an edge may be greater than the thickness of the interlayer along an opposing edge. In one or more embodiments, the longest edges of the interlayer have thicknesses that differ from one another, while the thicknesses of the other edges (shorter edges) are the same with respect to one another but vary along the length thereof to form the wedge shape. In one or more embodiments in which the interlayer has a wedge shape, the thickness ranges provided above are maximum thicknesses. In one or more embodiments, the interlayer has a wedge shape while the first strengthened glass substrate and/or the second glass substrate has a substantially uniform thickness.

In one or more embodiments, the total thickness of the laminate (including the first glass substrate, the interlayer and the second glass substrate) is less than about 7 mm, less than about 6.9 mm, less than about 6.8 mm, less than about 6.7 mm, less than about 6.6 mm, less than about 6.5 mm, less than about 6.4 mm, less than about 6.3 mm, less than about 6.2 mm, less than about 6.1, mm, less than about 6 mm, less than about 5.9 mm, less than about 5.8 mm, less than about 5.7 mm, less than about 5.6 mm, less than about 5.5 mm, less than about 5.4 mm, less than about 5.3 mm, less than about 5.2 mm, less than about 5.1, mm, less than about 4 mm, less than about 3.9 mm, less than about 3.8 mm, less than about 3.7 mm, less than about 3.6 mm, less than about 3.5 mm, less than about 3.4 mm, less than about 3.3 mm, less than about 3.2 mm, less than about 3.1, mm, less than about 3 mm, less than about 2.9 mm, less than about 2.8 mm, less than about 2.7 mm, less than about 2.6 mm, less than about 2.5 mm, less than about 2.4 mm, less than about 2.3 mm, less than about 2.2 mm, less than about 2 mm. In some embodiments, the total thickness of the laminate is about 2 mm or greater, about 2.2 mm or greater, about 2.4 mm or greater, about 2.5 mm or greater, about 2.6 mm or greater, about 2.8 mm or greater, about 3 mm or greater, about 3.2 mm or greater, about 3.4 mm or greater, about 3.5 mm or greater, about 3.6 mm or greater, about 3.8 mm or greater, about 4 mm or greater, about 4.2 mm or greater, about 4.4 mm or greater, about 4.5 mm or greater, about 4.6 mm or greater, about 4.8 mm or greater, or about 5 mm or greater. In some instances, the total thickness of the laminate is in the range from about 2 mm to about 7 mm, from about 2.2 mm to about 7 mm, from about 2.4 mm to about 7 mm, from about 2.5 mm to about 7 mm, from about 2.6 mm to about 7 mm, from about 2.8 mm to about 7 mm, from about 3 mm to about 7 mm, from about 3.2 mm to about 7 mm, from about 2 mm to about 6.8 mm, from about 2 mm to about 6.6 mm, from about 2 mm to about 6.5 mm, from about 2 mm to about 6.4 mm, from about 2 mm to about 6.2 mm, from about 2 mm to about 6 mm, from about 2 mm to about 5.8 mm, from about 2 mm to about 5.6 mm, from about 2 mm to about 5.5 mm, from about 2 mm to about 5.4 mm, from about 2 mm to about 5.2 mm, from about 2 mm to about 5 mm, from about 2 mm to about 4.8 mm, or from about 2 mm to about 4.6 mm.

In one or more embodiments, the laminate may have added functionality in terms of incorporating display aspects (e.g., heads up display, projection surfaces, and the like), antennas, solar insulation, acoustic performance (e.g., sound dampening), anti-glare performance, anti-reflective performance, scratch-resistance and the like. Such functionality may be imparted by coatings or layers applied to the exposed surfaces of the laminate or to interior (unexposed) surfaces between laminate substrates (e.g., between the glass substrates or between a glass substrate and an interlayer). In some embodiments, the laminate may have a thickness or configuration to enable improved optical performance when the laminate is used as a heads-up display (e.g., by incorporating a wedged shaped polymer interlayer between the glass sheets or by shaping one of the glass substrates to have a wedged shape). In one or more embodiments, the laminate includes a textured surface that provides anti-glare functionality and such textured surface may be disposed on an exposed surface or an interior surface that is unexposed. In one or more embodiments, the laminate may include an anti-reflective coating, a scratch-resistant coating or a combination thereof disposed on an exposed surface. In one or more embodiments, the laminate may include an antenna disposed on an exposed surface, and interior surface that is not exposed or embedded in any one of the glass substrates. In one or more embodiments, the polymer interlayer can be modified to have one or more of the following properties: ultraviolet (UV) absorption, Infrared (IR) absorption, IR reflection, acoustic control/dampening, adhesion promotion, and tint. The polymer interlayer can be modified by a suitable additive such as a dye, a pigment, dopants, etc. to impart the desired property.

The improved mechanical performance of the laminates described herein can prolong the life thereof and reduce replacement rates of such laminates. This becomes more beneficial as such laminates incorporate the added functionality described herein, and thus become more costly to repair or replace. In some embodiments, the prolonged life and reduced replacement rates are even more beneficial when the laminates with added functionality are used in auto glazing or, more specifically, as high performance windshields.

The materials for the first glass substrate and the second glass substrate may be varied. According to one or more embodiments, the materials for the second glass substrate and the second glass substrate may be the same material or different materials. In exemplary embodiments, one or both of the first glass substrate and the second glass substrate may be glass (e.g., soda lime glass, aluminosilicate glass, alkali aluminosilicate glass, alkali containing borosilicate glass and/or alkali aluminoborosilicate glass) or glass-ceramic (including Li₂O—Al₂O₃—SiO₂ system (i.e., LAS-System) glass ceramics, MgO—Al₂O₃—SiO₂ System (i.e., MAS-System) glass ceramics, glass ceramics including crystalline phases of any one or more of mullite, spinel, α-quartz, β-quartz solid solution, petalite, lithium dissilicate, β-spodumene, nepheline, and alumina).

The glass substrates may be provided using a variety of different processes. For instance, where the substrate includes a glass substrate, exemplary glass substrate forming methods include float glass processes and down-draw processes such as fusion draw and slot draw.

A glass substrate prepared by a float glass process may be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

Down-draw processes produce glass substrates having a uniform thickness that possess relatively pristine surfaces. Because the average flexural strength of the glass substrate is controlled by the amount and size of surface flaws, a pristine surface that has had minimal contact has a higher initial strength. When this high strength glass substrate is then further strengthened (e.g., chemically), the resultant strength can be higher than that of a glass substrate with a surface that has been lapped and polished. Down-drawn glass substrates may be drawn to a thickness of less than about 2 mm. In addition, down drawn glass substrates have a very flat, smooth surface that can be used in its final application without costly grinding and polishing.

The fusion draw process, for example, uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous substrate and into an annealing region.

Once formed, a glass substrate may be strengthened to form a strengthened glass substrate, as described herein. It should be noted that glass ceramic substrates may also be strengthened in the same manner as glass substrates.

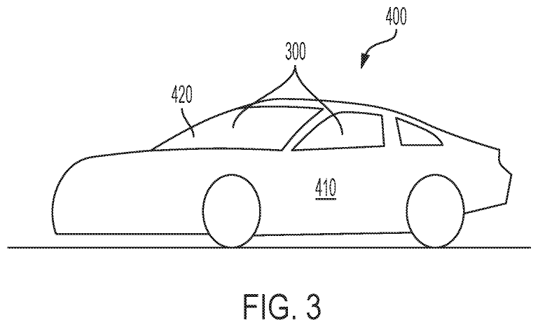

FIG. 3 illustrates an example of a vehicle 400 that includes the laminate 300 shown in FIG. 2. The vehicle includes a body 410 defining an interior and at least one opening 420 in the body. As used herein, the term “vehicle” may include automobiles (e.g., cars, vans, trucks, semi-trailer trucks, and motorcycles), rolling stock, locomotives, train cars, airplanes, and the like. The opening 420 is a window in communication with the interior of the vehicle and the exterior of the vehicle. The laminate 300 is disposed within then at least one opening 420 to provide a transparent covering. The second glass substrate 320 as shown in FIG. 2 is positioned so that it faces the (and in particular the fourth inner surface 329) interior of the vehicle while the first glass substrate 310 (and in particular first outer glass surface 311) would face the exterior of the vehicle. It should be noted that the laminates described herein may be used in architectural panels such as windows, interior wall panels, modular furniture panels, backsplashes, cabinet panels, and/or appliance panels.

### EXAMPLES

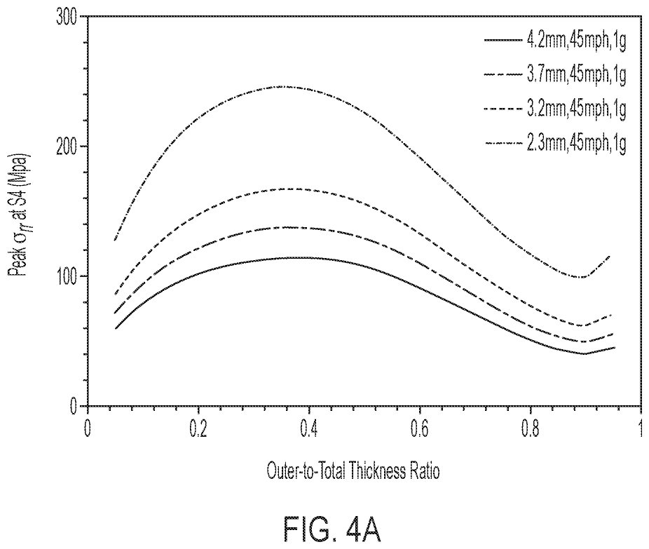

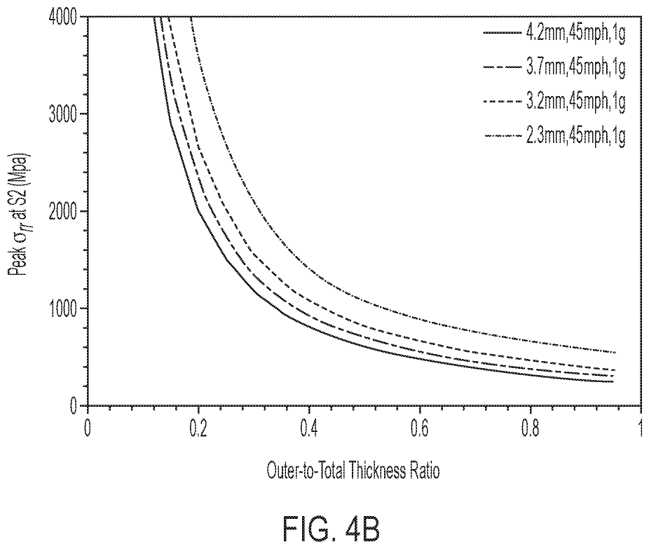

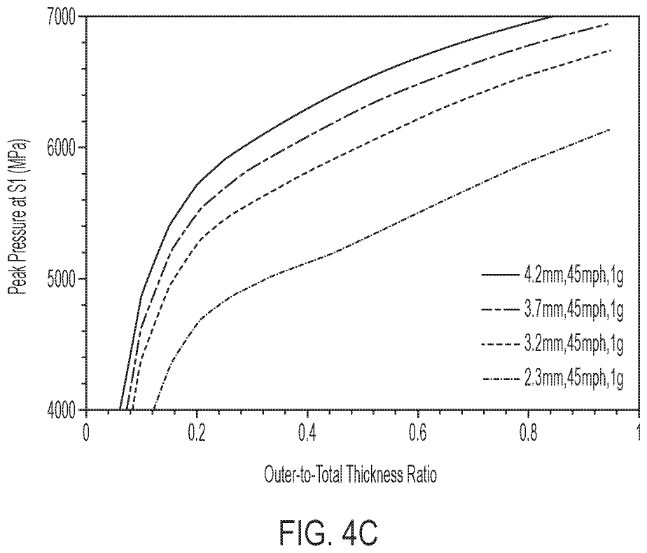

FIGS. 4A-4C are graphs showing predicted stress on a first outer surface, a second inner surface, and a fourth inner surface of various laminates as a function of the ratio of thickness of the first glass substrate to the total thickness (tₒ/tₜ ratio) for several total glass thickness (tₜ) values for laminates. In particular, each laminate stack has a total glass thickness tₜ, and the flexural stress σᵣᵣ (in MPa) on the respective surface of the respective glass substrate was modeled based on striking the outer surface of the second glass substrate with a 1 g ball bearing fired at the normal incidence and at 45 mph. To provide context and with reference to FIG. 1A, the model considered firing a 1 g ball bearing at normal incidence on the first outer surface 112 (also referred to below as S1) of the first glass substrate 110, and the flexural stress σᵣᵣ was calculated for the first outer surface 112 (or S1) and the second inner surface 115 (also referred to as S2) of the first glass substrate 110 and for the fourth inner surface 125 (also referred to below as S4) of the second glass substrate 120.

As can be seen in FIG. 4A, the peak stress σᵣᵣ on S4 increases as the total thickness tₜ decreases. Thus, for example, a laminate having a total thickness tₜ of 2.3 mm will experience a higher peak stress σᵣᵣ at all thickness ratios tₒ/tₜ than a laminate having a total thickness of, e.g., 3.2 mm, 3.7 mm, or 4.2 mm. Further, the maximum peak stress σᵣᵣ for all thicknesses tₜ is not located centrally at a tₒ/tₜ ratio of 0.5. Instead, the peak stress σᵣᵣ is located at a ratio of between about 0.32 and about 0.44 for each total thickness tₜ. That is, the maximum peak stress σᵣᵣ was calculated at ratios where the first glass substrate is thinner than the second glass substrate. The peak stress σᵣᵣ continuously decreases as each ratio decreases or increases from the tₒ/tₜ ratio at the maximum peak stress err. Going further to the right in tₒ/tₜ ratio (i.e., higher tₒ/tₜ ratio), though, causes the peak stress σᵣᵣ to drop lower than going to the left (i.e., lower tₒ/tₜ ratio). Indeed, the lowest peak stress σᵣᵣ values are found at a tₒ/tₜ ratio of 0.7 or above. That is, the lower peak stresses σᵣᵣ are found when the glass substrates of the laminate are highly asymmetrical, specifically with the first glass substrate (e.g., first glass substrate 110 of FIG. 1A) being much thicker than the second glass substrate (e.g., second glass substrate 120 of FIG. 1A). Table 1 provides the peak stress σᵣᵣ at various tₒ/tₜ ratio for various total glass thicknesses tₜ as calculated for S4.

TABLE 1
Peak Stress σᵣᵣ at tₒ/tₜ ratio 0.3-0.9 as measured on S4.

| Total | | | | | | | |
|---|---|---|---|---|---|---|---|
| Glass | | | | | | | |
| Thickness | Thickness tₒ/tₜ ratio | | | | | | |
| (tₜ) | 0.3 | 0.4 | 0.5 | 0.6 | 0.7 | 0.8 | 0.9 |
| 2.3 | 243 | 244 | 225 | 192 | 151 | 115 | 99 |
| 2.6 | 211 | 214 | 199 | 169 | 133 | 100 | 84 |
| 2.9 | 185 | 188 | 176 | 150 | 117 | 87 | 72 |
| 3.2 | 163 | 166 | 156 | 133 | 103 | 76 | 62 |
| 3.5 | 145 | 148 | 138 | 118 | 92 | 67 | 54 |
| 3.7 | 134 | 137 | 128 | 109 | 85 | 61 | 49 |
| 4 | 120 | 123 | 115 | 98 | 76 | 54 | 43 |
| 4.2 | 112 | 114 | 107 | 91 | 70 | 50 | 40 |

As can be seen from Table 1, the stress σᵣᵣ decreases as the total glass thickness tₜ increases and as the ratio tₒ/tₜ increases from the maximum peak stress σᵣᵣ between 0.3 and 0.5. This is also shown in FIG. 4A. The data in Table 1 was generated using models and confirmed using strain gauge (as discussed more fully below).

Based on the curves shown in FIG. 4A and on the data provided in Table 1, a relationship between peak stress σᵣᵣ and total thickness tₜ at a ratio tₒ/tₜ of 0.7 was found. In particular, the peak stress σᵣᵣ at a ratio of 0.7 tₒ/tₜ is related to the total glass thickness tₜ according to the relationship σᵣᵣ=10.344tₜ²−109.33tₜ+347.75. For a ratio tₒ/tₜ at or above 0.7, the peak stress σᵣᵣ is calculated to be no more than σᵣᵣ=10.344tₜ²−109.33tₜ+347.75 MPa for laminates having a total thickness tₜ of glass substrates between 2 mm and 7 mm. In general, the flexural stress σᵣᵣ is less than about 150 MPa for laminates having a total thickness tₜ of at least 2.4 mm and a tₒ/tₜ ratio of at least 0.7. Equations were also generated for a tₒ/tₜ of 0.8 and 0.9. The equation for peak stress σᵣᵣ at 0.8 is σᵣᵣ=9.3712tₜ²−94.614tₜ+283.33, and the equation for peak stress σᵣᵣ at 0.9 is σᵣᵣ=9.9862tₜ²−95.671tₜ+266.23.

As can be seen in FIG. 4B, the peak stress σᵣᵣ on S2 increases as the total thickness tₜ decreases. Further, as tₒ/tₜ increases, the peak stress σᵣᵣ decreases for all glass laminate thicknesses. Table 2 provides the peak stress σᵣᵣ at various tₒ/tₜ ratio for various total glass thicknesses tₜ as calculated for S2.

TABLE 2
Peak Stress σᵣᵣ at tₒ/tₜ ratio 0.3-0.9 as measured on S2.

| Total | | | | | | | |
|---|---|---|---|---|---|---|---|
| Glass | | | | | | | |
| Thickness | Thickness tₒ/tₜ ratio | | | | | | |
| (tₜ) | 0.3 | 0.4 | 0.5 | 0.6 | 0.7 | 0.8 | 0.9 |
| 2.3 | 2074 | 1410 | 1081 | 890 | 761 | 663 | 584 |
| 2.6 | 1879 | 1284 | 985 | 806 | 684 | 590 | 515 |
| 2.9 | 1708 | 1173 | 898 | 730 | 614 | 526 | 455 |
| 3.2 | 1559 | 1074 | 819 | 661 | 553 | 470 | 404 |
| 3.5 | 1430 | 985 | 747 | 600 | 498 | 421 | 359 |
| 3.7 | 1352 | 930 | 704 | 563 | 465 | 392 | 333 |
| 4 | 1248 | 856 | 644 | 513 | 421 | 353 | 299 |
| 4.2 | 1185 | 810 | 608 | 482 | 395 | 330 | 279 |

Based on the curves shown in FIG. 4B and on the data provided in Table 2, a relationship between peak stress σᵣᵣ and total thickness tₜ at a ratio tₒ/tₜ of 0.7 was found. In particular, the peak stress σᵣᵣ at a ratio of 0.7 tₒ/tₜ is related to the total tₜ according to the relationship σᵣᵣ=38.345tₜ²−441.01tₜ+1572. For a ratio tₒ/tₜ at or above 0.7, the peak stress Err is calculated to be no more than σᵣᵣ=38.345tₜ²−441.01tₜ+1572 MPa for laminates having a total thickness tₜ of glass substrates between 2 mm and 7 mm. Equations were also generated for a tₒ/tₜ of 0.8 and 0.9. The equation for peak stress σᵣᵣ at 0.8 is σᵣᵣ=38.634tₜ²−425.33tₜ+1436.1, and the equation for peak stress σᵣᵣ at 0.9 is σᵣᵣ=39.119tₜ²−413.77tₜ+1328.1.

As can be seen in FIG. 4C, the peak stress σᵣᵣ on S1 increases as the total thickness tₜ increases. Further, as tₒ/tₜ increases, the peak stress σᵣᵣ increases for all glass laminate thicknesses. Table 3 provides the peak stress σᵣᵣ at various tₒ/tₜ ratio for various total glass thicknesses tₜ as calculated for S1.

TABLE 3
Peak Stress σᵣᵣ at tₒ/tₜ ratio 0.3-0.9 as measured on S1.

| Total | | | | | | | |
|---|---|---|---|---|---|---|---|
| Glass | | | | | | | |
| Thickness | Thickness tₒ/tₜ ratio | | | | | | |
| (tₜ) | 0.3 | 0.4 | 0.5 | 0.6 | 0.7 | 0.8 | 0.9 |
| 2.3 | 4957 | 5113 | 5300 | 5505 | 5706 | 5895 | 6074 |
| 2.6 | 5199 | 5381 | 5583 | 5789 | 5984 | 6161 | 6324 |
| 2.9 | 5407 | 5613 | 5821 | 6026 | 6214 | 6378 | 6525 |
| 3.2 | 5589 | 5812 | 6023 | 6225 | 6403 | 6556 | 6689 |
| 3.5 | 5750 | 5984 | 6196 | 6392 | 6562 | 6703 | 6823 |
| 3.7 | 5847 | 6085 | 6296 | 6489 | 6653 | 6787 | 6900 |
| 4 | 5980 | 6219 | 6428 | 6616 | 6771 | 6896 | 6997 |
| 4.2 | 6061 | 6298 | 6507 | 6690 | 6840 | 6958 | 7054 |

Based on the curves shown in FIG. 4C and on the data provided in Table 3, a relationship between peak stress σᵣᵣ and total thickness tₜ at a ratio tₒ/tₜ of 0.7 was found. In particular, the peak stress σᵣᵣ at a ratio of 0.7 tₒ/tₜ is related to the total tₜ according to the relationship σᵣᵣ=10.344tₜ²−109.33tₜ+347.75. For a ratio tₒ/tₜ at or above 0.7, the peak stress Err is calculated to be no more than σᵣᵣ=10.344tₜ²−109.33tₜ+347.75 MPa for laminates having a total thickness tₜ of glass substrates between 2 mm and 7 mm. Equations were also generated for a tₒ/tₜ of 0.8 and 0.9. The equation for peak stress σᵣᵣ at 0.8 is σᵣᵣ=9.3712tₜ²−94.614tₜ+283.33, and the equation for peak stress σᵣᵣ at 0.9 is σᵣᵣ=9.9862tₜ²−95.671tₜ+266.23.

Without wishing to be bound by theory, the inventors believe that, in a highly asymmetric laminate, the flexural stress is primarily absorbed by the thick glass substrate that is struck by the ball bearing. Further, the stress σᵣᵣ experienced by both substrates is proportional to the thickness of the substrate divided by the bending radius. Because the thicker glass substrate absorbs more of the stress and the thinner glass substrate has a lower thickness, the stress σᵣᵣ is proportionally lower. For certain applications, such as automotive glazing (e.g., windshields), the lower flexural stress means that the inboard, thin glass substrate is less likely to break inwardly towards the vehicle occupants.

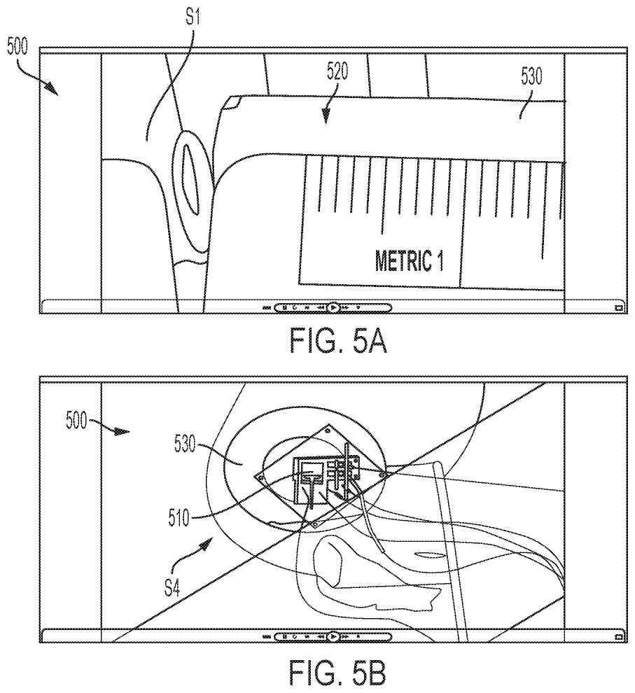

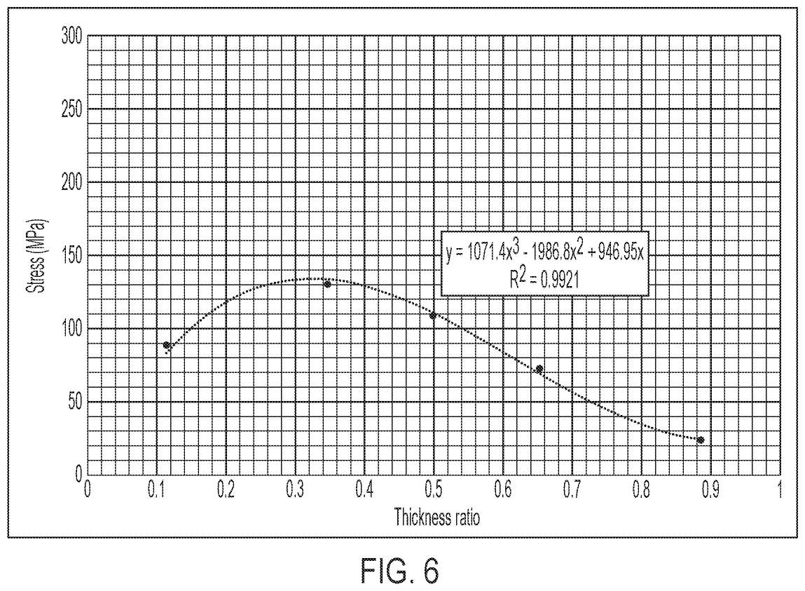

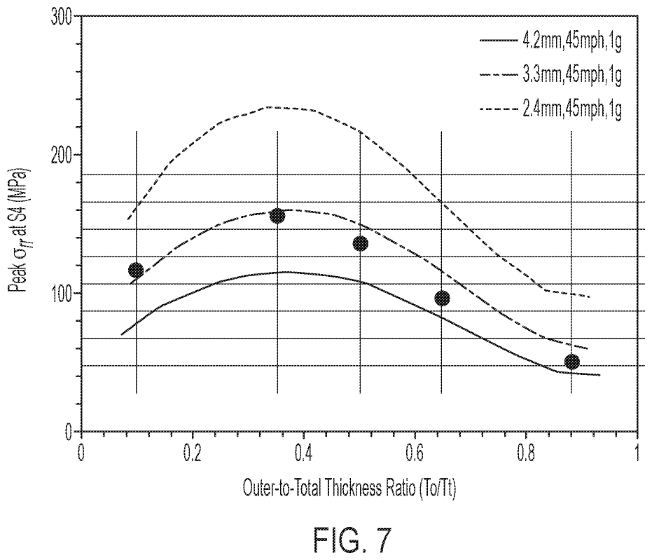

The experiment modeled to generate the curves shown in FIG. 4 was performed to confirm the shape of the modeled curves. In particular, FIGS. 5A and 5B depict the experimental arrangement 500 by which the data was gathered for stress measurements determined on S4. A strain gage rosette 510 was placed on S4, and strain was measured at 40 kHz. As mentioned, a ball bearing 520 was fired from a barrel 530 directly across from the strain gage rosette 510 at normal incidence. The strain was converted to stress using the Young's modulus of the glass substrate. FIG. 6 provides a plot of the calculated stress for a laminate having a total glass thickness (tₜ) of 3.2 for tₒ/tₜ ratios from about 0.1 to about 0.9. FIG. 6 experimentally confirms the curves generated in FIG. 4. Indeed, FIG. 7 provides an overlay of the data points shown in FIG. 6 on the curves shown in FIG. 4.

In another experiment, the ball bearing was fired at S1 at a 45 degree angle. The velocity of the ball bearing was increased until a breakage event occurred, i.e., one of the glass substrates of the glass laminate broke. Tables 4 and 5 provide breakage data for glass laminates having a total glass thickness (tₜ) of about 3.2 mm and about 3.7 mm, respectively. In Tables 4 and 5, the number (n) of breakage events is provided along with “Front only” breaks (i.e., only the front glass substrate of the glass laminate breaks), “Back only” breaks (i.e., only the back glass substrate of the glass laminate breaks), “Both” breaks (i.e., both the front and back glass substrate of the glass laminate break), “% Back only” (i.e., 100*(“Back only”)/n), and % Back total (i.e., 100*(“Back only”+“Both”)/n).

TABLE 4
Breakage data for 45° impact on tₜ of about 3.2 mm

| Glass Ply | | | Front | Back | | % Back | % Back |
|---|---|---|---|---|---|---|---|
| thicknesses | tₒ/tₜ | n | only | only | Both | only | total |
| 0.4/3.1 | 0.11 | 20 | 20 | 0 | 0 | 0 | 0 |
| 0.55/2.66 | 0.17 | 20 | 20 | 0 | 0 | 0 | 0 |
| 0.7/2.21 | 0.24 | 20 | 6 | 11 | 3 | 55 | 70 |
| 1.1/2.07 | 0.35 | 20 | 3 | 17 | 0 | 85 | 85 |
| 1.4/1.84 | 0.43 | 20 | 3 | 17 | 0 | 85 | 85 |
| 1.6/1.6 | 0.5 | 28 | 16 | 8 | 3 | 29 | 39 |
| 1.84/1.4 | 0.57 | 24 | 11 | 5 | 8 | 21 | 54 |
| 2.07/1.1 | 0.65 | 20 | 15 | 0 | 5 | 0 | 25 |
| 2.21/0.7 | 0.76 | 20 | 13 | 0 | 7 | 0 | 35 |
| 2.26/0.55 | 0.83 | 20 | 18 | 0 | 2 | 0 | 10 |
| 3.1/0.4 | 0.89 | 20 | 14 | 0 | 6 | 0 | 30 |

TABLE 5
Breakage data for 45° impact on tₜ of about 3.7 mm

| Glass Ply | | | Front | Back | | % Back | % Back |
|---|---|---|---|---|---|---|---|
| thicknesses | Tₒ/tₜ | N | only | only | Both | only | total |
| 0.5/3.1 | 0.15 | 20 | 20 | 0 | 0 | 0 | 0 |
| 0.7/3.1 | 0.18 | 20 | 19 | 1 | 0 | 0 | 5 |
| 1.1/2.66 | 0.29 | 20 | 6 | 14 | 0 | 0 | 70 |
| 1.4/2.24 | 0.38 | 20 | 7 | 12 | 1 | 5 | 65 |
| 1.6/2.07 | 0.44 | 20 | 10 | 7 | 3 | 15 | 50 |
| 1.84/1.84 | 0.5 | 20 | 13 | 4 | 3 | 15 | 35 |
| 2.07/1.6 | 0.56 | 20 | 12 | 7 | 1 | 5 | 40 |
| 2.24/1.4 | 0.62 | 20 | 11 | 2 | 7 | 10 | 45 |
| 2.66/1.1 | 0.71 | 20 | 19 | 0 | 1 | 0 | 5 |
| 3.1/0.7 | 0.82 | 20 | 12 | 0 | 8 | 0 | 0 |
| 3.1/0.55 | 0.85 | 20 | 10 | 0 | 10 | 0 | 50 |

The data from Tables 4 and 5 indicate that the back glass substrate (which faces the interior of a vehicle) is highest for tₒ/tₜ ratios between 0.24 and 0.65. This data is consistent with the modeled data shown in FIG. 4 and the experimental data shown in FIG. 6. For glass laminates having a high tₒ/tₜ (>0.65), it was determined that the mode of breakage for the front glass substrate was cone break, and S4 of the back glass substrate exhibited biaxial fracture.

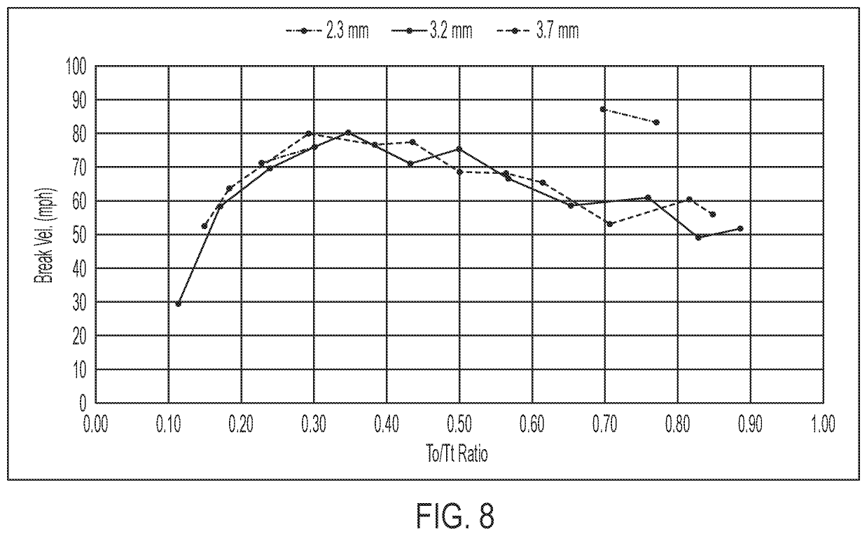

FIG. 8 provides a graph of the velocity required to induce a breakage as a function of tₒ/tₜ ratio. From FIG. 8, it can be seen that symmetric parts take the highest velocity to induce breakage from the ball bearing, which probably occurs as a result of the higher flexibility as compared to asymmetric parts. As mentioned above, the failure mode for glass laminates having a high tₒ/tₜ ratio tends to be cone break of the front glass substrate, resulting in higher stress on S4 and possibly a biaxial flexure break of S4 of the back glass substrate. For glass laminates having a low tₒ/tₜ ratio, S2 of the front glass substrate breaks from biaxial flexure. Notwithstanding, a majority of breaks found in the field are result from sharp impact events (about 75-80%), whereas cone breaks only account for about 10-20% of breaks.

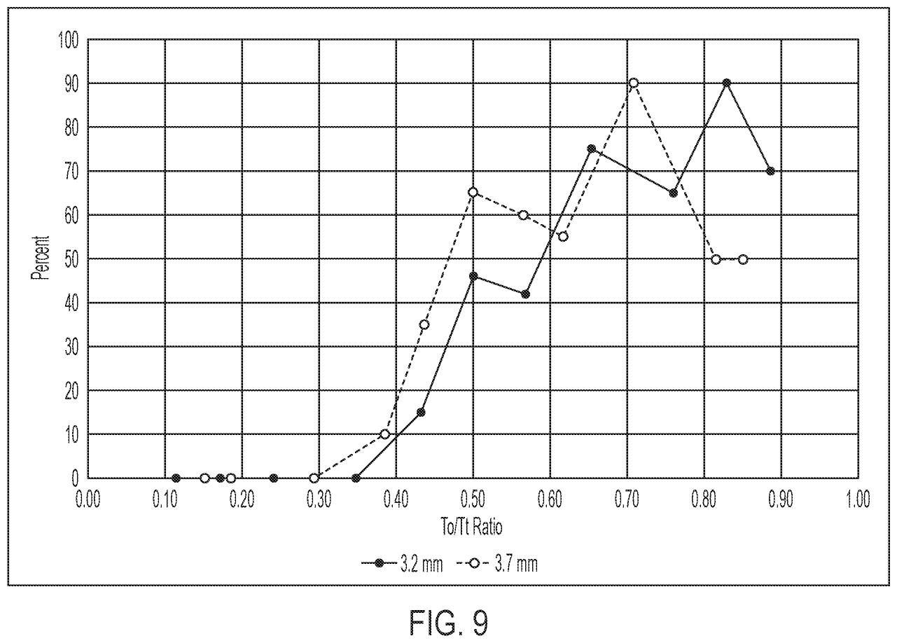

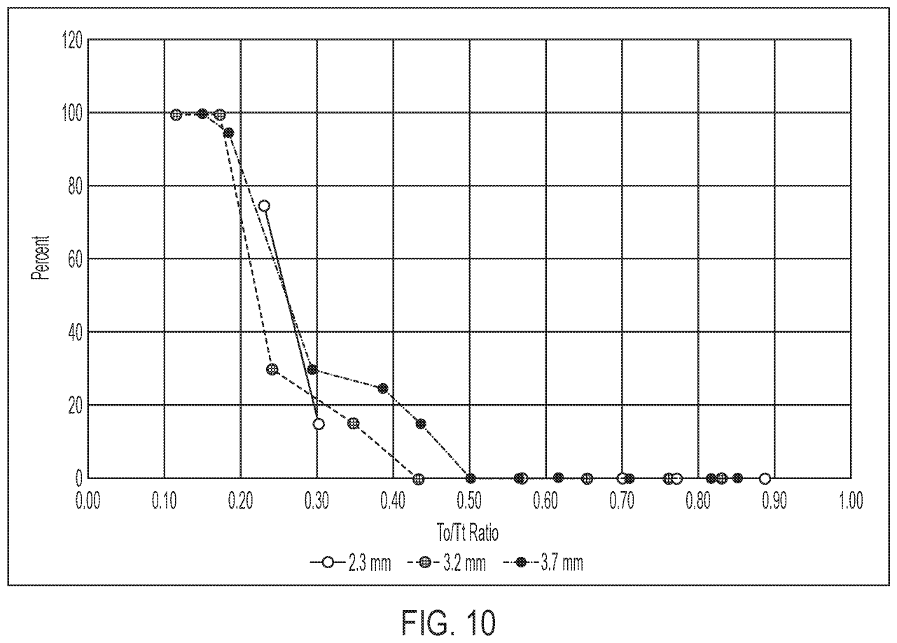

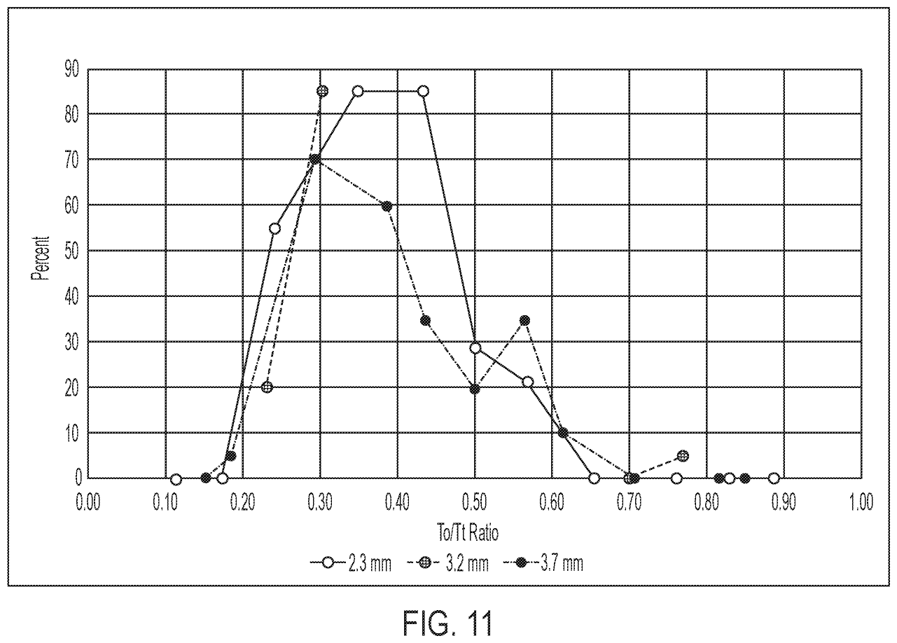

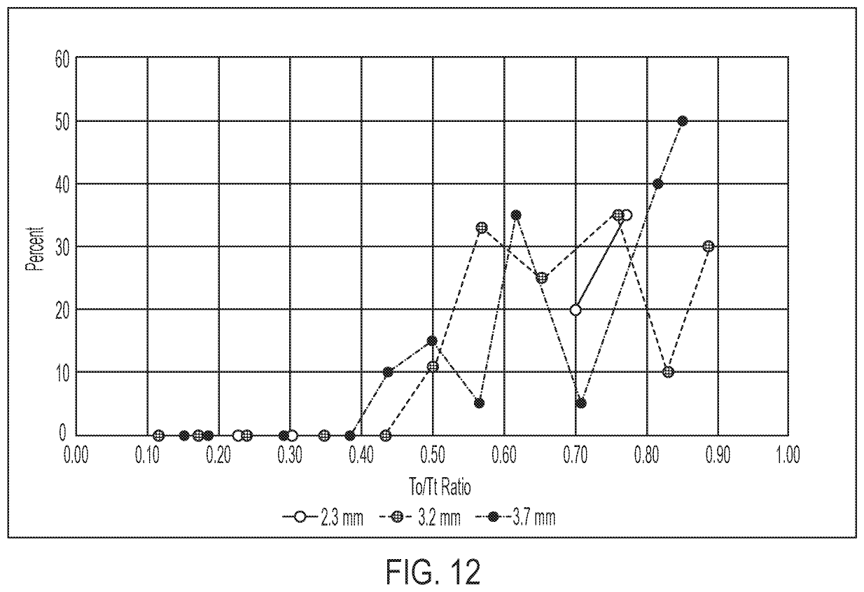

FIGS. 9-12 provide graphs of particular failure modes by percentage as a function of tₒ/tₜ ratio. As can be seen in FIG. 9, a higher tₒ/tₜ ratio tends to produce cone breakage on the front glass substrate more so than a low tₒ/tₜ ratio. FIG. 10 demonstrates that the front glass substrate biaxially fractures at a low tₒ/tₜ ratio. FIG. 11 demonstrates that the back glass substrate surface S4 fractures biaxially at symmetric tₒ/tₜ ratios (e.g., between 0.20 and 0.60). Finally, FIG. 12 demonstrates that, at tₒ/tₜ ratios of above 0.5, the glass laminate increasingly tends to break via cone breakage of the front glass substrate and biaxially fracture of the back glass substrate as the tₒ/tₜ ratio increases.

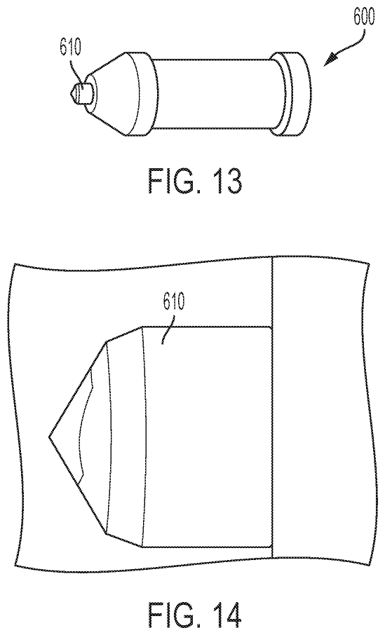

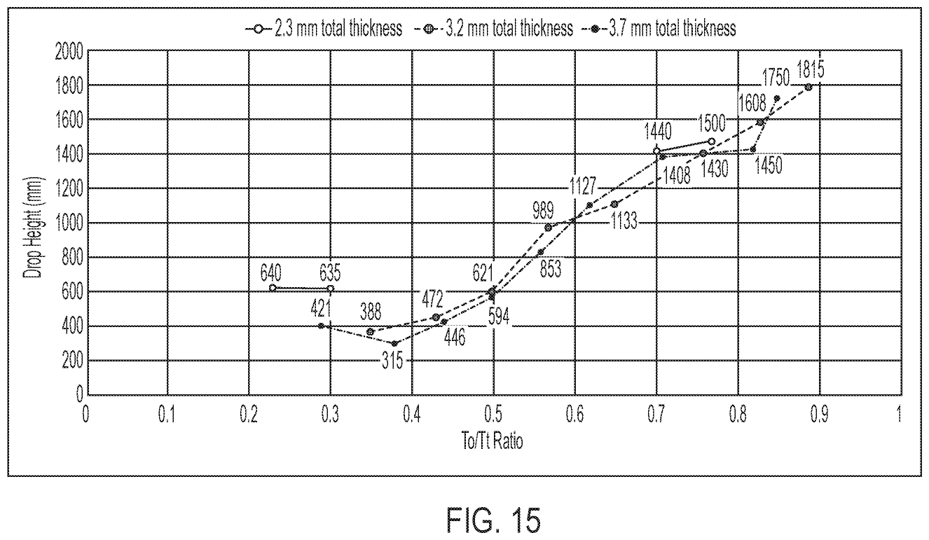

As mentioned, because most breakages in the field are the result of sharp impact, another experiment was performed in which a dart was dropped onto glass laminates having various tₒ/tₜ ratios. In the test, an 8.5 g dart with a Vickers diamond tip (120° conical diamond) was dropped from height onto the glass laminates. The dart 600 is shown in FIG. 13, and a close-up of the tip 610 is shown in FIG. 14. FIG. 15 is a graph demonstrating the drop height (in millimeters) required to break a glass laminate of a particular tₒ/tₜ ratio. As can be seen in FIG. 15, there is a strong correlation between the height needed to break the glass laminate and the tₒ/tₜ ratio. In particular, an increasingly higher height was needed as the tₒ/tₜ ratio increased.

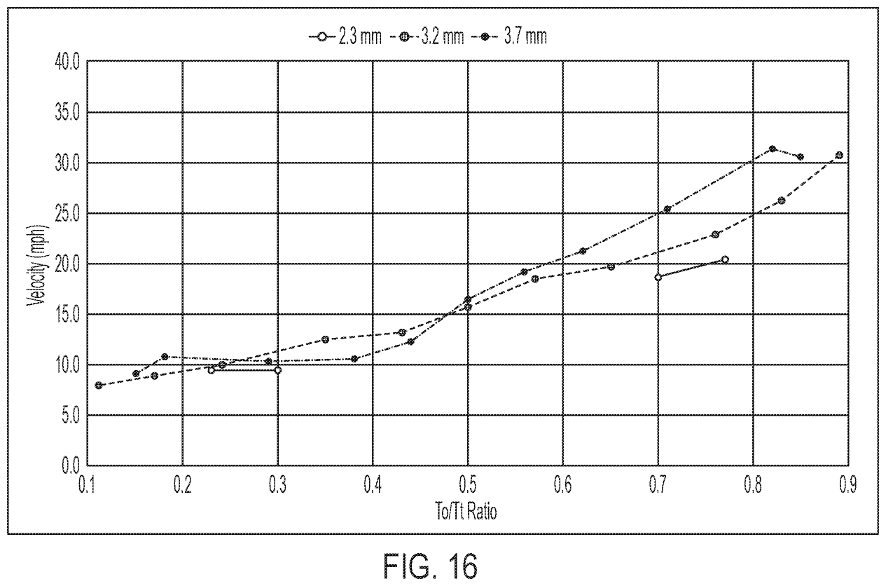

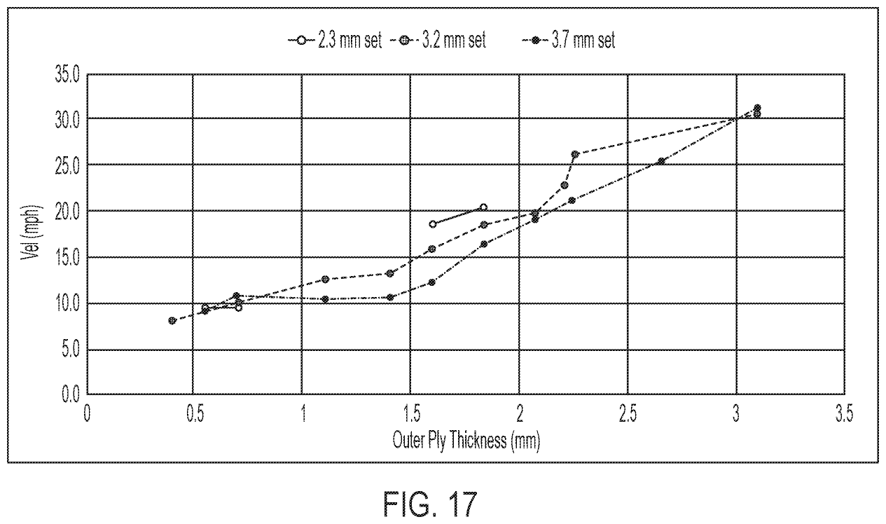

In another test, a 2 g dart (substantially similar to the dart of FIGS. 13 and 14 except in mass) was fired at glass laminates of various tₒ/tₜ ratios. The darts impacted normal to the glass laminates. FIG. 16 depicts the velocity of the dart required to break the glass laminate. Again, it can be seen that glass laminates having a higher tₒ/tₜ ratio perform better than glass laminates having a lower tₒ/tₜ ratio in that a higher dart velocity is required to break the glass laminates. In FIG. 17, the dart velocity is plotted against the thickness of the front glass substrate. As can be seen, the increased velocity required to break a glass laminate with a high tₒ/tₜ ratio is driven primarily by the thickness of the front glass substrate.

In embodiments, the laminate is used for automotive glazing, such as windshields, rear windows, sunroofs, etc. in a vehicle, and is very highly asymmetric, e.g., having a tₒ/tₜ ratio of 0.95 or higher, 0.96 or higher, 0.97 or higher, 0.98 or higher, 0.99 or higher, or up to 0.999. In such embodiments, the total glass thickness tₜ is no more than 5 mm, and the second glass substrate has a thickness tᵢ of less than 0.1 mm. Advantageously, such laminates are believed to not only provide significant weight savings, but they also are believed to exhibit the same low flexural stress σᵣᵣ discussed above.

Further, in certain embodiments, it may be beneficial to provide the thinner glass substrate as the outer surface (e.g., as depicted in FIG. 2). As mentioned briefly above, the peak stress σᵣᵣ also decreases from its maximum as the tₒ/tₜ ratio decreases. In particular, at a tₒ/tₜ ratio of 0.12 or less, the peak stress σᵣᵣ as measured on the fourth inner surface of the thicker second glass substrate is also below about 150 MPa for laminates having a total glass thickness tₜ of 2.4 mm or above. In embodiments, the ratio tₒ/tₜ is as low as 0.001 (i.e., highly asymmetrical with the first glass substrate being much thinner than the second glass substrate).

According to an aspect (1) of the present disclosure, a laminate is provided. The laminate comprising: a first glass substrate comprising a first thickness (tₒ) and a first outer surface and a second inner surface; a second glass substrate comprising a second thickness (tᵢ) that is less than to, a third outer surface, and a fourth inner surface; an interlayer disposed between the second inner surface and the third outer surface; wherein a third thickness (tₜ) is equal to the sum of to and tᵢ; wherein tₒ/tₜ is in a range of from 0.7 to 0.999; and wherein, when the first outer surface is impacted at normal incidence with a 1 gram ball bearing traveling at a speed of 45 mph, the fourth inner surface experiences a flexural stress (σᵣᵣ) of no more than σᵣᵣ=10.344tₜ²−109.33tₜ+347.75 as measured by strain gauge for tₜ in a range of from 2 mm to 7 mm.

According to an aspect (2) of the present disclosure, the laminate of aspect (1) is provided, wherein the second glass substrate comprises a soda-lime silicate glass composition, an aluminosilicate glass composition, or an alkali aluminosilicate glass composition.

According to an aspect (3) of the present disclosure, the laminate of any of aspects (1)-(2) is provided, wherein the second glass substrate comprises a second glass comprising a surface compressive stress (CS) of no more than 300 MPa.

According to an aspect (4) of the present disclosure, the laminate of any of aspects (1)-(3) is provided, wherein the second glass substrate comprises a strengthened glass substrate.

According to an aspect (5) of the present disclosure, the laminate of aspect (4) is provided, wherein the second glass substrate comprises a surface CS in a range from about 50 MPa to 300 MPa.

According to an aspect (6) of the present disclosure, the laminate of any of aspects (4)-(5) is provided, wherein the second glass substrate comprises a depth of compression (DOC) in a range from about 30 μm to about 90 μm.

According to an aspect (7) of the present disclosure, the laminate of any of aspects (1)-(3) is provided, wherein the second glass substrate is unstrengthened.

According to an aspect (8) of the present disclosure, the laminate of any of aspects (1)-(3) is provided, wherein the second glass substrate comprises an annealed glass substrate.

According to an aspect (9) of the present disclosure, the laminate of any of aspects (1)-(8) is provided, wherein the interlayer is a polymer selected from the group consisting of polyvinyl butyral, ethylenevinylacetate, polyvinyl chloride, ionomers, and thermoplastic polyurethane.

According to an aspect (10) of the present disclosure, the laminate of any of aspects (1)-(9) is provided, wherein the interlayer has a thickness of 2 mm or greater.

According to an aspect (11) of the present disclosure, the laminate of any of aspects (1)-(10) is provided, wherein the interlayer has a modulus of elasticity of about 200 MPa or less.

According to an aspect (12) of the present disclosure, the laminate of any of aspects (1)-(11) is provided, wherein the laminate comprises an automotive glazing, or an architectural panel.

According to an aspect (13) of the present disclosure, a laminate is provided. The laminate comprising: a first glass substrate comprising a first thickness (tₒ) between a first outer surface and a second inner surface; a second glass substrate comprising a second thickness (tᵢ) that is less than to between a third outer surface and a fourth inner surface; and an interlayer disposed between and adhered to second inner surface and the third outer surface; wherein a third thickness (tₜ) is the sum of to and tᵢ; wherein, when the first outer surface is impacted at normal incidence with a 1 gram ball bearing traveling at a speed of 45 mile per hour, the fourth inner surface exhibits a flexural stress of less than about 150 MPa, as measured by a strain gage, for tₜ of 2.4 mm or greater.

According to an aspect (14) of the present disclosure, the laminate of aspect (13) is provided, wherein tₒ/tₜ is in a range of from about 0.7 to about 0.999.

According to an aspect (15) of the present disclosure, the laminate of aspect (13) is provided, wherein tᵢ/tₜ is in the range of from 0.12 to 0.001.

According to an aspect (16) of the present disclosure, the laminate of any of aspects (13)-(15) is provided, wherein tₜ is up to about 7 mm.

According to an aspect (17) of the present disclosure, the laminate of any of aspects (13)-(16) is provided, wherein the second glass substrate comprises a soda-lime silicate glass composition, an aluminosilicate glass composition, or an alkali aluminosilicate glass composition.

According to an aspect (18) of the present disclosure, the laminate of any of aspects (13)-(17) is provided, wherein the second glass substrate comprises a surface compressive stress of no more than 300 MPa.

According to an aspect (19) of the present disclosure, the laminate of any of aspects (13)-(18) is provided, wherein the second glass substrate comprises a strengthened glass substrate.

According to an aspect (20) of the present disclosure, the laminate of aspect (19) is provided, wherein the second glass substrate comprises a surface CS in a range from about 50 MPa to 300 MPa.

According to an aspect (21) of the present disclosure, the laminate of any of aspects (19)-(20) is provided, wherein the second glass substrate comprises a DOC in a range from about 30 μm to about 90 μm.

According to an aspect (22) of the present disclosure, the laminate of any of aspects (13)-(18) is provided, wherein the second glass substrate is unstrengthened.

According to an aspect (23) of the present disclosure, the laminate of any of aspects (13)-(18) is provided, wherein the second glass substrate comprises an annealed glass substrate.

According to an aspect (24) of the present disclosure, the laminate of any of aspects (13)-(23) is provided, wherein the interlayer is a polymer selected from the group consisting of polyvinyl butyral, ethylenevinylacetate, polyvinyl chloride, ionomers, and thermoplastic polyurethane.

According to an aspect (25) of the present disclosure, the laminate of any of aspects (13)-(24) is provided, wherein the interlayer has a thickness of 2 mm or greater.

According to an aspect (26) of the present disclosure, the laminate of any of aspects (13)-(25) is provided, wherein the interlayer has a modulus of elasticity of about 200 MPa or less.

According to an aspect (27) of the present disclosure, a vehicle is provided. The vehicle comprising: a body defining an interior; an opening in the body in communication with the interior; and the laminate of any of aspects (1)-(11) and aspects (13)-(26) disposed in the opening.

According to an aspect (28) of the present disclosure, the vehicle of aspect (27) is provided, wherein the body comprises an automobile body, a railcar body, or an airplane body.

According to an aspect (29) of the present disclosure, the vehicle of any of aspects (27)-(28) is provided, wherein the second glass substrate faces the interior.

According to an aspect (30) of the present disclosure, an architectural panel is provided. The architectural panel comprising the laminate of any of aspects (1)-(11) and aspects (13)-(26), wherein the panel comprises a window, an interior wall panel, a modular furniture panel, a backsplash, a cabinet panel, or an appliance panel.

According to an aspect (31) of the present disclosure, an automotive glazing is provided. The automotive glazing comprising: a first glass substrate comprising a first thickness (tₒ) and a first outer surface and a second inner surface; a second glass substrate comprising a second thickness (tᵢ) that is less than to, a third outer surface, and a fourth inner surface; an interlayer disposed between the second inner surface and the third outer surface; wherein a third thickness (tₜ) is equal to the sum of to and t; wherein tₒ/tₜ is in a range of from 0.95 to 0.999; and wherein t^{t} is less than 0.1 mm and tₜ is in a range of from 2 mm to 5 mm.

According to an aspect (32) of the present disclosure, the automotive glazing of aspect (31) is provided, wherein the automotive glazing is at least one of a windshield, a rear window, or a sunroof of a vehicle.

According to an aspect (33) of the present disclosure, the automotive glazing of any of aspects (31)-(32) is provided, wherein the second glass substrate comprises a soda-lime silicate glass composition, an aluminosilicate glass composition, or an alkali aluminosilicate glass composition.

According to an aspect (34) of the present disclosure, the automotive glazing of any of aspects (31)-(33) is provided, wherein the second glass substrate comprises a surface compressive stress of no more than 300 MPa.

According to an aspect (35) of the present disclosure, the automotive glazing of any of aspects (31)-(34) is provided, wherein the second glass substrate comprises a strengthened glass substrate.

According to an aspect (36) of the present disclosure, the automotive glazing of aspect (35) is provided, wherein the second glass substrate comprises a surface CS in a range from about 50 MPa to 300 MPa.

According to an aspect (37) of the present disclosure, the automotive glazing of any of aspects (35)-(36) is provided, wherein the second glass substrate comprises a DOC in a range from about 30 μm to about 90 μm.

According to an aspect (38) of the present disclosure, the automotive glazing of any of aspects (31)-(34) is provided, wherein the second glass substrate is unstrengthened.

According to an aspect (39) of the present disclosure, the automotive glazing of any of aspects (31)-(34) is provided, wherein the second glass substrate comprises an annealed glass substrate.

According to an aspect (40) of the present disclosure, the automotive glazing of any of aspects (31)-(34) is provided, wherein the interlayer is a polymer selected from the group consisting of polyvinyl butyral, ethylenevinylacetate, polyvinyl chloride, ionomers, and thermoplastic polyurethane.

According to an aspect (41) of the present disclosure, the automotive glazing of any of aspects (31)-(40) is provided, wherein the interlayer has a thickness of 2 mm or greater.

According to an aspect (42) of the present disclosure, the automotive glazing of any of aspects (31)-(41) is provided, wherein the interlayer has a modulus of elasticity of about 200 MPa or less.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

What is claimed is:

1. A laminate comprising:
a first glass substrate comprising a first thickness (tₒ) and a first outer surface and a second inner surface;
a second glass substrate comprising a second thickness (tᵢ) that is less than to, a third outer surface, and a fourth inner surface;
an interlayer disposed between the second inner surface and the third outer surface;
wherein a third thickness (tₜ) is equal to the sum of to and tᵢ;
wherein tₒ/tₜ is in a range of from 0.7 to 0.999; and
wherein, when the first outer surface is impacted at normal incidence with a 1 gram ball bearing traveling at a speed of 45 mph, the fourth inner surface experiences a flexural stress (σᵣᵣ) of no more than σᵣᵣ=10.344tₜ²−109.33tₜ+347.75 as measured by strain gauge for tₜ in a range of from 2 mm to 7 mm.

2. The laminate of claim 1, wherein the second glass substrate comprises a soda-lime silicate glass composition, an aluminosilicate glass composition, or an alkali aluminosilicate glass composition.

3. The laminate of claim 1, wherein the second glass substrate comprises a second glass comprising a surface compressive stress (CS) of no more than 300 MPa

4. The laminate of claim 1, wherein the second glass substrate comprises a strengthened glass substrate.

5. The laminate of claim 4, wherein the second glass substrate comprises at least one of a surface CS in a range from about 50 MPa to 300 MPa and a depth of compression (DOC) in a range from about 30 μm to about 90 μm.

6. The laminate of claim 1, wherein the second glass substrate is unstrengthened.

7. The laminate of claim 1, wherein the second glass substrate comprises an annealed glass substrate.

8. The laminate of claim 1, wherein the interlayer is a polymer selected from the group consisting of polyvinyl butyral, ethylenevinylacetate, polyvinyl chloride, ionomers, and thermoplastic polyurethane.

9. A laminate comprising:
a first glass substrate comprising a first thickness (tₒ) between a first outer surface and a second inner surface;
a second glass substrate comprising a second thickness (tᵢ) that is less than to between a third outer surface and a fourth inner surface; and
an interlayer disposed between and adhered to second inner surface and the third outer surface;
wherein a third thickness (tₜ) is the sum of to and tᵢ;
wherein, when the first outer surface is impacted at normal incidence with a 1 gram ball bearing traveling at a speed of 45 mile per hour, the fourth inner surface exhibits a flexural stress of less than about 150 MPa, as measured by a strain gage, for tₜ of 2.4 mm or greater.

10. The laminate of claim 9, wherein tₒ/tₜ is in a range of from about 0.7 to about 0.999.

11. The laminate of claim 9, wherein tᵢ/tₜ is in the range of from 0.12 to 0.001.

12. The laminate of claim 9, wherein tₜ is up to about 7 mm.

13. The laminate of claim 9, wherein the second glass substrate comprises a soda-lime silicate glass composition, an aluminosilicate glass composition, or an alkali aluminosilicate glass composition.

14. The laminate of claim 9, wherein the second glass substrate comprises a surface compressive stress of no more than 300 MPa.

15. The laminate of claim 9, wherein the second glass substrate comprises a strengthened glass substrate.

16. The laminate of claim 9, wherein the second glass substrate is unstrengthened.

17. The laminate of claim 9, wherein the second glass substrate comprises an annealed glass substrate.

18. The laminate of claim 9, wherein the interlayer is a polymer selected from the group consisting of polyvinyl butyral, ethylenevinylacetate, polyvinyl chloride, ionomers, and thermoplastic polyurethane.

19. A vehicle comprising: a body defining an interior; an opening in the body in communication with the interior; and the laminate of claim 1 disposed in the opening.

20. The vehicle of claim 19, wherein the body comprises an automobile body, a railcar body, or an airplane body.

21. The vehicle of claim 19, wherein the second glass substrate faces the interior.

22. An architectural panel comprising the laminate of claim 1, wherein the panel comprises a window, an interior wall panel, a modular furniture panel, a backsplash, a cabinet panel, or an appliance panel.

23. An automotive glazing comprising:
a first glass substrate comprising a first thickness (tₒ) and a first outer surface and a second inner surface;
a second glass substrate comprising a second thickness (tᵢ) that is less than to, a third outer surface, and a fourth inner surface;
an interlayer disposed between the second inner surface and the third outer surface;
wherein a third thickness (tₜ) is equal to the sum of to and tᵢ;
wherein tₒ/tₜ is in a range of from 0.95 to 0.999; and
wherein tᵢ is less than 0.1 mm and tₜ is in a range of from 2 mm to 5 mm.

24. The automotive glazing of claim 23, wherein the automotive glazing is at least one of a windshield, a rear window, or a sunroof of a vehicle.

25. The automotive glazing of claim 23, wherein the second glass substrate comprises a soda-lime silicate glass composition, an aluminosilicate glass composition, or an alkali aluminosilicate glass composition.

26. The automotive glazing of any claim 23, wherein the second glass substrate comprises a surface compressive stress of no more than 300 MPa.

27. The automotive glazing of any claim 23, wherein the second glass substrate comprises a strengthened glass substrate.

28. The automotive glazing of any claim 23, wherein the second glass substrate is unstrengthened.

29. The automotive glazing of any claim 23, wherein the second glass substrate comprises an annealed glass substrate.

30. The automotive glazing of any claim 23, wherein the interlayer is a polymer selected from the group consisting of polyvinyl butyral, ethylenevinylacetate, polyvinyl chloride, ionomers, and thermoplastic polyurethane.
